(19) United States
(12) Patent Application Publication
(10) Pub. No.: US 2017/0088744 A1
(43) Pub. Date: Mar. 30, 2017

(54) COATING COMPOSITIONS FOR COIL COATING, METHODS FOR MAKING SUCH COATING COMPOSITIONS AND COIL COATING METHODS

(71) Applicant: AXALTA COATING SYSTEMS IP CO., LLC, Wilmington, DE (US)

(72) Inventors: Peter UHLIANUK, Romeo, MI (US); Michelle H. DYKE, Troy, MI (US); Erich G. SMITH, Ishpeming, MI (US)

(73) Assignee: AXALTA COATING SYSTEMS IP CO., LLC, Wilmington, DE (US)

(21) Appl. No.: 15/377,584

(22) Filed: Dec. 13, 2016

Related U.S. Application Data
(63) Continuation of application No. 14/285,879, filed on May 23, 2014.

(51) Int. Cl. C09D 163/00; C09D 5/00; C08G 59/40; C09D 7/12; C08G 59/18

(52) U.S. Cl. CPC C09D 163/00; C09D 7/125; C08G 59/184; C08G 59/4028; C09D 5/002

(57) ABSTRACT

Coating compositions for coil coating, methods for making such coating compositions and coil coating methods are provided. In an exemplary embodiment, a coating composition includes an aqueous carrier and a film-forming binder dispersed in the aqueous carrier. The film-forming binder contains an epoxy-amine adduct and a blocked polyisocyanate crosslinking agent. The film-forming binder has associated amine/acid groups until subjected to heat of at least about 165.5° C. (330° F.). The coating composition also contains a pigment and a grinding resin. The coating composition has a solids content of at least about 40 wt. % based on a total weight of the coating composition.

### CROSS-REFERENCE TO RELATED APPLICATION

This application is a continuation of U.S. application Ser. No. 14/285,879, filed May 23, 2014, which is incorporated herein by reference in its entirety.

### TECHNICAL FIELD

The present invention generally relates to coating compositions, methods for making coating compositions, and processes for using coating compositions, and more particularly relates to coating compositions for coil coating, methods for making coating compositions for coil coating, and coil coating methods.

### BACKGROUND

Coil coating is a continuous, automated process for coating metal with a primer, a bottom coat of paint or a top coat of paint before fabrication into end products. The metal substrate, typically of steel or aluminum, is delivered in coil form from a rolling mill. The metal coil is positioned at the beginning of a coating line, and in one continuous process, the coil is unwound, pre-cleaned, pre-treated, pre-primed, and prepainted, typically using roller coating, before being recoiled on the other end and packaged for shipment. This process can be performed at up to about 213 meters (700 feet) per second.

Conventional coil coating paints (referred to herein as “coating compositions”) suffer from several drawbacks. Typically, the coating compositions contain nonvolatile particles in the range of from about 20 to about 30 weight percent based on the total weight of the coating composition and further contain volatile solvents. As a result, to comply with government environmental regulations, volatile organic compound (VOC) collectors and oxidizers are required on process ovens to minimize VOCs released into the atmosphere. In addition, corrosion of the metal after coating is an ongoing problem.

Accordingly, it is desirable to provide a water-based coil coating composition with a relatively high solids content that exhibits improved corrosion resistance after the coil coating process. In addition, it is desirable to provide a method for manufacturing such a coating composition. It also is desirable to provide a coil coating process using such a coating composition. Furthermore, other desirable features and characteristics of the present invention will become apparent from the subsequent detailed description of the invention and the appended claims, taken in conjunction with the accompanying drawings and this background of the invention.

### BRIEF SUMMARY

Coating compositions for coil coating, methods for making such coating compositions and coil coating methods are provided. In an exemplary embodiment, a coating composition includes an aqueous carrier and a film-forming binder dispersed in the aqueous carrier. The film-forming binder contains an epoxy-amine adduct and a blocked polyisocyanate crosslinking agent. The film-forming binder has associated amine/acid groups until subjected to heat of at least about 165.5° C. (330° F.). The coating composition also contains a pigment and a grinding resin. The coating composition has a solids content of at least about 40 wt. % based on a total weight of the coating composition.

In another exemplary embodiment, a method for making a coating composition includes combining a polyepoxide and a polyether polyol to form a mixture and heating the mixture. A crosslinking agent is added to the mixture and a cationic group former is added to the mixture. An acid is added to the mixture to form a film-forming binder. The film-forming binder is combined with a pigment paste. The coating composition has a solids content of at least about 40 weight percent based on a total weight of the coating composition. The film-forming binder has associated amine/acid groups until subjected to heat of at least about 165.5° C. (330° F.).

In a further exemplary embodiment, a method for coil coating a metal coil includes unwinding a metal strip from a coil thereof. The metal strip is cleaned and at least one surface of the metal strip is coated with a coating composition to form a coated metal strip. The coating composition includes an aqueous carrier and a film-forming binder dispersed in the aqueous carrier. The film-forming binder contains an epoxy-amine adduct and a blocked polyisocyanate crosslinking agent. The film-forming binder has associated amine/acid groups until subjected to heat of at least about 165.5° C. (330° F.). The film-forming binder also contains a pigment and a grinding resin. The coating composition has a solids content of at least about 40 weight percent based on a total weight of the coating composition. The coated metal strip is heated.

### BRIEF DESCRIPTION OF THE DRAWINGS

The present invention will hereinafter be described in conjunction with the following drawing FIGURES, wherein like numerals denote like elements, and wherein:

FIG. 1 is a side view of a conventional coil coating process.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various embodiments contemplated herein relate to coating compositions for use in coil coating. Unlike conventional coating compositions used for coil coating, the coating compositions contemplated herein are aqueous-based compositions having nonvolatile solids contents of at least 40 weight percent (wt. %) based on the total weight of the coating compositions. In this regard, the coating compositions contemplated herein exhibit superior corrosion resistance than conventional coating compositions. The higher solids content of the coating compositions contemplated herein further translates into a lower VOC content than conventional coating compositions. While the coating compositions set forth herein are described as useful for coil coating processes, it will be appreciated that the coating compositions are not so limited and can be used for the coating and/or painting of most if not all metal structures, for example, stamped metal parts, such as those manufactured and used in the automobile industry, extruded metal parts, molded metal parts, and the like in any painting process such as spray painting, dip painting, roller painting, brush painting, and the like.

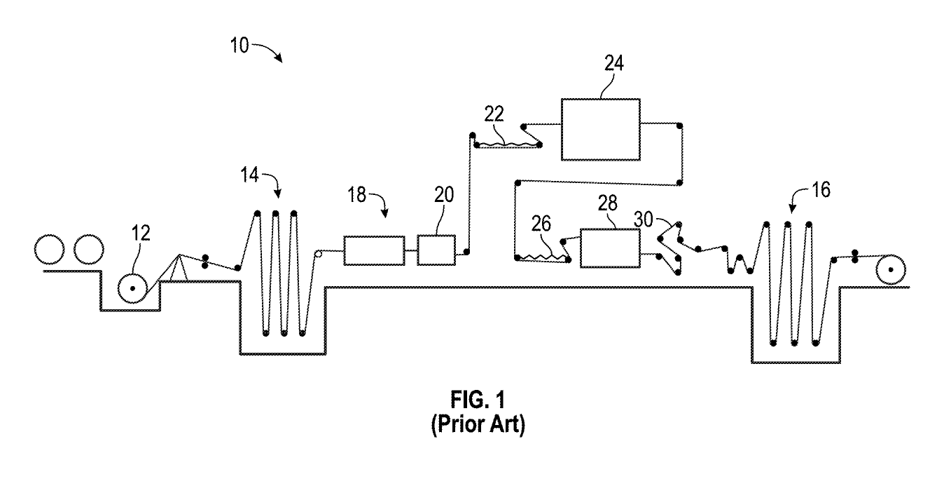

A side view of a conventional coil coating process 10 is illustrated in FIG. 1. The coil coating process is a continuous feeding operation with a metal strip of the coil fed through the entire coating process. The metal strip may be a strip of steel, aluminum, cast iron, or other metal or metal alloy. A coil 12 is first fed into an entrance accumulator tower 14 and after coating is fed into an exit accumulator tower 16, with the accumulator towers 14, 16 allowing the coating operation to continue at constant speed even when intake of the metal strip of the coil is delayed, for example to start a new roll, or winding of the metal strip after coating is delayed, for example to cut the metal to end one roll and begin a new roll. The coil is generally cleaned to remove oil or debris and pretreated at a pretreatment station 18 and dried in a dryer 20. The metal strip then is primed on one or both sides of the strip with a primer 22 and baked in a curing oven 24 to cure the primer. Subsequently, the metal strip is coated at least on one side with a top coat composition 26. The metal strip typically is coated by roller coating but can also be coated by brush coating, spray coating, dip coating, and the like. The top coating is generally not applied by electrodeposition in coil coating processes due to safety issues. A separate backer or a different topcoat may be applied on the other side. The topcoat is deposited to a thickness in the range of about 15.24 microns (μm) (0.6 mils) to about 25.4 μm (1 mil). The topcoat is baked in a finishing oven 28 at a temperature of about 204.4° C. (400° F.) to about 537.8° C. (1000° F.) and quenched in a water quench 30. The metal strip then is fed into the exit accumulator tower 16 and from there is re-rolled.

In accordance with an exemplary embodiment, the coating composition used in the coil coating process, that is, the top coat composition 26, contains a film-forming binder, an aqueous carrier, a pigment and a grind resin. The film-forming binder of the principal emulsion used to form the coating composition is an epoxy amine adduct and a blocked polyisocyanate crosslinking agent and is dispersed in the aqueous medium. The binder is present in amounts of about 30-50% by weight of solids. The film-forming binder of the coating composition contemplated herein is formed from contacting and heating together a polyepoxide with a polymeric polyol, described below, the reaction product of which is chain extended followed by reaction with a cationic base group former, also described below. The resulting reaction product then is combined with a cross-linking agent.

The polyepoxide resins that are used to form the film-forming binder are polymers having a 1,2-epoxy equivalency greater than one, for example, about two, that is, polyepoxides that have on an average basis two epoxy groups per molecule. Exemplary polyepoxides are polyglycidyl ethers of cyclic polyols. Particularly suitable are polyglycidyl ethers of polyhydric phenols such as bisphenol A. These polyepoxides can be produced by etherification of polyhydric phenols with epichlorohydrin or dichlorohydrin in the presence of alkali. Examples of polyhydric phenols are 2,2-bis-(4-hydroxyphenyl)propane, 1,1-bis-(4-hydroxyphenyl)ethane, 2-methyl-1,1-bis-(4-hydroxyphenyl)propane, 2,2-bis-(4-hydroxy-3-tertiarybutylphenyl)propane, bis-(2-hydroxynapthyl) methane, 1,5-dihydroxy-3-naphthalene, or the like. Examples of other cyclic polyols include alicyclic polyols, particularly cycloaliphatic polyols, such as 1,2-cyclohexanediol, 1,4-cyclohexanediol, 1,2-bis(hydroxymethyl)cyclohexane, 1,3-bis(hydroxymethyl)cyclohexane and hydrogenated bisphenol A.

Examples of other polyepoxides are polyglycidyl ethers of polyhydric alcohols, such as ethylene glycol, diethylene glycol, triethylene glycol, 1,2-propylene glycol, 1,3-propylene glycol, 1,4-butylene glycol, 1,5-pentanediol and the like. The polyepoxides have molecular weights of at least about 200, for example within the range of about 200 to 2000, such as about 340 to about 2000.

In an exemplary embodiment, the polymeric polyol that is contacted and heated with the polyepoxide is a polyether polyol formed from reacting a cyclic polyol with ethylene oxide. Optionally, the polyether polyol can be formed by reacting a cyclic polyol with a mixture of ethylene oxide and an alkylene oxide having 3 to 4 carbon atoms in the alkylene chain.

The polyether polyol is prepared by techniques known in the art. Typical reaction conditions are as follows: The cyclic polyol is charged to a reactor capable of maintaining pressure. If the cyclic polyol is a liquid or low melting solid, for example, cyclohexanedimethanol, it can be added to the reactor neat. If the cyclic polyol is a solid or a high viscosity liquid, it can be dissolved in a suitable solvent. For example, bisphenol A can be dissolved as a 50 percent solution in methyl isobutyl ketone. Resorcinol can be dissolved in water. A catalyst such as a tertiary amine, for example, N,N′-dimethylcyclohexylamine, or an alkali metal hydroxide, for example, sodium hydroxide or potassium hydroxide, is usually added to the reaction mixture in an amount of about 0.5 to 2 percent by weight based on total weight of the reaction mixture. The cyclic polyol is heated to about 82° C. (180° F.) to about 104° C. (219° F.) and the reactor pressured with nitrogen to about 2.8 to about 4.2 kilograms per square centimeter (kg/cm²) (about 40 to about 60 pounds per square inch (psi)).

Ethylene oxide also under pressure, usually at about 5.6 to about 7.0 kg/cm² (about 80 to about 100 psi), is fed into the reactor slowly in an incremental manner with cooling to remove the exothermic heat obtained when the ethylene oxide reacts with the cyclic polyol. Throughout the addition that lasts about 3 to 4 hours, the temperature of the reaction vessel is kept at about 82 (180° F.) to about 121° C. (250° F.). At the completion of the ethylene oxide addition, the reaction mixture is held for about 1 to 2 hours at about 93 (199° F.)-121° C. (250° F.) to complete the reaction. If solvent was present, it is stripped off and if sodium hydroxide or potassium hydroxide catalyst were used, they can be neutralized with acid, for example, phosphoric acid, and the salt filtered off. If a mixture of ethylene oxide and higher alkylene oxide is used, in an embodiment, the reaction proceeds first with the higher alkylene oxide and then with the ethylene oxide.

Examples of the cyclic polyols that can be used are polyhydric phenols and cycloaliphatic polyols such as those mentioned above in connection with the preparation of the polyepoxides. Also, cyclic polyols such as the aromatic diols, resorcinol, the aryl-alkyl diols such as the various isomeric xylene diols and heterocyclic diols such as 1,4-piperizine diethanol can be used.

As mentioned above, besides ethylene oxide, mixtures of ethylene oxide and an alkylene oxide containing from 3 to 6, such as 3 to 4 carbon atoms in the alkylene chain can be used. Examples of such alkylene oxides are 1-2-propylene oxide, 1-methyl-1,2-propylene oxide, 1,2-butylene oxide, butadiene monoepoxide, epichlorohydrin, glycidol, cyclohexane oxide and styrene oxide, with 1,2-propylene oxide being preferred.

In an embodiment, the cyclic polyol-alkylene oxide condensate is difunctional or trifunctional, that is, it contains an average of 2 to 3 hydroxyl groups per molecule. Higher functional polyethers can be employed, although gelation could pose a challenge. An example of a higher functionality polyether is the reaction product of a cyclic polyol such as sucrose with ethylene oxide.

The equivalent ratio of cyclic polyol to alkylene oxide should be within the range of 1:3 to 20, for example 1:3 to 15. When the ratio is less than 1:3, the resultant coating has insufficient flexibility. When the ratio is greater than 1:20, the cured films will have poorer salt spray corrosion resistance. The exemplary cyclic polyol-alkylene oxide condensates used in the coating compositions contemplated herein are believed to have the following structural formula:

R—((OX)ₘ(OC2H4)ₙ—OH)_{z}

where R is a cyclic radical, m is equal to 0 to 18, n is equal to 1 to 15, n plus m is equal to 1 to 20, X is an alkylene radical of 3 to 8 carbon atoms, and Z is equal to 2 to 3.

The polyepoxide and the polyether polyol can be contacted by simply mixing the two together, optionally in the presence of a solvent such as aromatic hydrocarbons, for example, toluene, xylene and ketones, such as, methyl ethyl ketone and methyl isobutyl ketone. The polyepoxide and the polyether polyol are heated together, for example at a temperature of at least 75° C. (167° F.), for example, at least 90° C. (194° F.), such as 100 (212° F.) to 180° C. (356° F.), usually in the presence of a catalyst, such as 0.05 to 2 percent by weight tertiary amines or quaternary ammonium bases. The time the polyepoxide and polyether polyol are heated together will vary depending on the amounts contacted, how they are contacted, the degree of agitation, temperature, and the presence of catalyst. In general, when the polyepoxide and polyether polyol are contacted in an agitated reactor, they are heated for a time sufficient to increase the epoxy equivalency of the reaction mixture. In an embodiment, the epoxy equivalency should be increased at least 25, for example at least 50, such as from about 75-150 percent over its original value; the epoxide equivalent being determined according to ASTM D-1652 (gram of resin solids containing 1-gram-equivalent of epoxide). In an embodiment, the ratio of equivalents of active hydrogen, e.g., hydroxyl, in the polyether polyol to equivalents of 1,2-epoxy in the polyepoxide should be about less than 1, for example about 0.1 to about 0.8:1, such as about 0.3 to about 0.6:1.

The polyepoxide and the polyether polyol are contacted and heated together to form a resinous reaction product or resin. Although the nature of the resinous reaction product is not completely understood, it is believed to be a mixture of about 15 to about 45 percent by weight of a chain-extended polyepoxide, that is, polyepoxide molecules linked together with polyether polyol molecules and about 55 to about 85 percent by weight of unreacted polyether polyol and unreacted polyepoxide or polyepoxide reacted with itself.

In another exemplary embodiment, the polymeric polyol used in forming the film-forming binder is a polyester polyol. Polyester polyols can be prepared by polyesterification of organic polycarboxylic acids or anhydrides thereof with organic polyols containing primary or secondary hydroxyls. Usually the polycarboxylic acids and polyols are aliphatic or aromatic dibasic acids and diols. The diols that are usually employed in making the polyester include alkylene glycol, such as ethylene glycol and butylene glycol, neopentyl glycol and other glycols such as cyclohexanedimethanol.

The acid component of the polyester consists primarily of monomeric carboxylic acids or anhydrides having 2 to 28 carbon atoms per molecule. Among the acids that are useful are phthalic acid, isophthalic acid, terephthalic acid, tetrahydrophthalic acid, hexahydrophthalic acid, adipic acid, azelaic acid, sebacic acid, maleic acid, glutaric acid, chlorendic acid, tetrachlorophthalic acid and the like. Where acids are referred to above, it is understood that the anhydrides of those acids that form anhydrides can be used in place of acid.

Besides polyester polyols formed from polybasic acids of polyols, lactone polyesters can also be employed. These products are formed from the reaction of lactone such as epsilon-caprolactone with a polyol. The polylactone polyols that are obtained from this reaction are characterized by the presence of terminal hydroxyl groups and recurring polyester moieties derived from the lactone, that is,

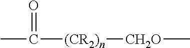

wherein n is at least 4, for example from 4 to 6, and at least n+2R are hydrogen and the remaining R substituents are selected from the group consisting of hydrogen, alkyl, cycloalkyl, and alkoxy, none of the substituents contain more than 12 carbon atoms and the total number of carbon atoms in the substituents in the lactone ring does not exceed 12.

The lactone used as the starting material may be any lactone, or combination of lactones, having at least 6 carbon atoms, for example, from 6 to 8 carbon atoms in the ring and at least two hydrogen substituents on the carbon atom that is attached to the oxy group in the ring. The lactone used as the starting material can be represented by the following general formula:

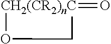

where n and R have the meanings referred to above.

The lactones useful herein are the epsilon-caprolactones in which n equals 4 in the above structure. In an embodiment, the lactone is unsubstituted epsilon-caprolactone, in which n equals 4 and all of the R's in the above structure are hydrogen. Epsilon-caprolactone is particularly useful because it is readily available in commercial quantities and gives excellent coating properties. Various lactones may be utilized individually or in combination. The polycaprolactone polyols suitable for use herein have molecular weights within the range of 530 to 2000 Daltons.

Examples of suitable aliphatic diols include ethylene glycol, 1,3-propanediol, 1,4-butanedio, 1,5-pentanediol, 1,6-hexanediol, 1,10-decanediol and 1,4-cyclohexanedimethanol. An example of suitable aliphatic triol is trimethylolpropane. The suitable polycaprolactone polyols have molecular weights within the range of 530 to 2000.

Polymerization of the lactone is initiated by reaction with an organic polyol containing primary hydroxyls. Organic polyols that are particularly suitable for use herein are aliphatic diols and triols such as alkylene diols containing from 2 to 10 carbon atoms.

The resinous reaction product of the polyepoxide and the polymeric polyol is reacted with a cationic group former, for example, an amine and then neutralized with an acid. The amines used to adduct the epoxy resin are monoamines, particularly secondary amines with primary hydroxyl groups. When reacting the secondary amine containing the primary hydroxyl group with the terminal epoxide groups in the polyepoxide, the result is the amine/epoxy adduct in which the amine has become tertiary and contains a primary hydroxyl group. Examples of useful primary and secondary amines include diethyl amine, methyl ethyl amine, methyl ethanol amine, ethyl ethanol amine, mono ethanol amine, ethyl amine, dimethyl amine, diethyl amine, propyl amine, dipropyl amine, isopropyl amine, diisopropyl amine, butyl amine, dibutyl amine and the like. Alkanol amines such as methyl ethanol amine are particularly useful.

In addition to the amines disclosed above, a portion of the amine that is reacted with the polyepoxide-polyol product can be the ketimine of a polyamine. The ketimine groups will decompose upon dispersing the amine-epoxy reaction product in water resulting in free primary amine groups that would be reactive with curing agents. Ketimines useful herein are prepared from ketones and primary amines. The water formed is removed, for example by azeotropic distillation. Useful ketones include dialkyl, diaryl and alkylaryl ketones having 3-13 carbon atoms. Specific examples include acetone, methyl ethyl ketone, methyl n-butyl ketone, methyl isobutyl ketone, methyl isoamyl ketone, methyl aryl ketone, ethyl isoamyl ketone, ethyl amyl ketone, acetophenone, and benzophenone. Suitable diamines are ethylene diamine, 1,3-diaminopropane, 1,4-diaminobutane, 1,6-diaminohexane, 4,9-dioxadodecone, 1,12-diamine and the like. A particularly useful ketamine is diketimine, which is the ketamine of diethylene triamine and methyl isobutyl ketone. Mixtures of the various amines also can be used.

The reaction of the secondary amine with the resinous reaction product of the polyepoxide and the polymeric polyol takes place upon mixing the amine with the polyepoxide. The reaction can be conducted neat, or, optionally in the presence of suitable solvent. The reaction may be exothermic and cooling may be desired. However, heating to a moderate temperature, that is, within the range of 50° C. (122° F.) to 150° C. (302° F.) may be used to hasten the reaction.

The reaction product of the amine with the polyepoxide/polyol reaction product attains its cationic character by at least partial neutralization with acid. Examples of suitable acids include organic and inorganic acids such as formic acid, acetic acid, lactic acid, and phosphoric acid. The extent of neutralization will depend upon the particular product involved. It is only necessary that sufficient acid be used to disperse the product in water. Typically, the amount of acid used will be sufficient to provide at least about 30 percent of the total theoretical neutralization. Excess acid beyond that required for 100 percent total theoretical neutralization can also be used. The amine/acid groups remain associated with the film-forming binder of the coating composition until the coating composition is subjected to heat of at least about 165.5° C. (330° F.).

In an exemplary embodiment, the extent of cationic group formation of the resin is selected such that when the resin is mixed with aqueous medium, a stable dispersion will form. A stable dispersion is one which does not settle or is one that is easily redispersible if some sedimentation occurs. In an exemplary embodiment, the cationic resins prepared according to the methods contemplated herein contain from about 10 to about 300, such as from about 30 to about 100, milliequivalents of cationic group per hundred grams of resin solids.

As noted above, the film-forming binder of the principal emulsion used to form the coating composition contemplated herein is an epoxy amine adduct and a blocked polyisocyanate crosslinking agent dispersed in the aqueous medium. Examples of polyisocyanate crosslinking agents suitable for use in the film-forming binder are aliphatic, cycloaliphatic and aromatic isocyanates such as hexamethylene diisocyanate, cyclohexamethylene diisocyanate, toluene diisocyanate, methylene diphenyl diisocyanate and the like. These isocyanates are pre-reacted with a blocking agent such as oximes, alcohols, or caprolactams that block the isocyanate functionality, i.e., the crosslinking functionality. In an exemplary embodiment, a mixture of blocking agents is methanol, ethanol and diethylene glycol monobutyl ether. Upon heating, the blocking agents separate, thereby providing a reactive isocyanate group and crosslinking occurs. The film-forming binder of the electrocoating composition typically contains about 40-60% by weight epoxy amine adduct and about 60-40% by weight blocked isocyanate and are the principal resinous ingredients in the coating composition.

In addition to the film-forming binder described above, the coating composition contemplated herein further contains pigment that is incorporated into the composition in the form of a pigment paste. The pigment paste is prepared by grinding or dispersing a pigment into a grinding resin and optional ingredients such as wetting agents, surfactants, and defoamers. Any of the pigment grinding resins that are well known in the art can be used. After grinding with the grinding resin, the particle size of the pigment should be as small as practical, for example, the particle size is about 6-8 using a Hegman grinding gauge. In an exemplary embodiment, the pigment paste has a nonvolatile solids content of at least 30 wt. % based on the total weight of the coating composition, for example, 40 wt. %, based on the total weight of the coating composition.

Pigments that can be used in the coating composition contemplated herein include titanium dioxide, basic lead silicate, strontium chromate, carbon black, iron oxide, zinc hydroxy phosphite, lead, bismuth, tin, clay and the like. Pigments with high surface areas and oil absorbencies should be used judiciously because these can have an undesirable effect on coalescence and flow of the coating composition.

The pigment-to-film-forming binder weight ratio is, for example, less than 0.5:1, for example less than 0.4:1, such as about 0.2 to 0.4:1. Higher pigment-to-film-former binder weight ratios have been found to adversely affect coalescence and flow.

The coating composition contemplated herein can contain optional ingredients such as, for example, wetting agents, surfactants, defoamers, anti-crater additives, and the like. Examples of surfactants and wetting agents include alkyl imidazolines, acetylenic alcohols available from Air Products and Chemicals, Inc. of Allentown, Pennsylvania as “Surfynol® 104,” and ethoxylated styrenated phenols such as “Syn Fac® 8334” available from Milliken Chemical of Spartanburg, S.C. These optional ingredients, when present, constitute from about 0.1 to 20 percent by weight of the film-forming binder of the coating composition.

Optionally, plasticizers can be used to promote flow. Examples of useful plasticizers are high boiling point water immiscible materials such as ethylene or propylene oxide adducts of nonyl phenols or bisphenol A. Plasticizers are usually used at levels of about 0.1 to 15 percent by weight of the film-forming binder of the coating composition.

The coating composition contemplated herein is an aqueous dispersion. The term “dispersion” as used herein is a two-phase translucent or opaque aqueous resinous binder system in which the binder is in the dispersed phase and water the continuous phase. The average particle size diameter of the binder phase is about 0.1 to about 10 microns, for example, less than 5 microns. The concentration of the binder in the aqueous medium in general is not critical, but ordinarily the major portion of the aqueous dispersion is water. The aqueous dispersion usually contains from about 3 to about 50, for example, 5 to 40 percent by weight binder solids. In an exemplary embodiment, the coating composition contains a nonvolatile solids content of at least 40 weight percent (wt. %) based on the total weight of the coating compositions, for example, about 40 to about 60 wt. % nonvolatile solids, for example 45 wt. % nonvolatile solids, such as 50 wt. % nonvolatile solids based on the total weight of the coating composition. In this regard, the coating composition contemplated herein exhibits superior corrosion resistance than conventional coating compositions. The higher solids content of the coating compositions contemplated herein further translates into a lower VOC content than conventional coating compositions. The coating composition has a weight average molecular weight (Mw) in the range of about 2,000 to about 6,000 Mw, for example, 4000 Mw.

Besides water, the aqueous medium may also contain a coalescing solvent. Useful coalescing solvents include hydrocarbons, alcohols, particularly polyols, esters, ethers and ketones. Specific coalescing solvents include monobutyl and monohexyl ethers of ethylene glycol and phenyl ether of propylene glycol. The amount of coalescing solvent is not unduly critical and is, for example, between about 0 to about 15 percent by weight, such as 0.5 to about 5 percent by weight, based on the total weight of the film-forming binder solids.

In accordance with an exemplary embodiment, and as noted above, a method for making a coating composition contemplated herein includes combining the polyepoxide and the polyether polyol, optionally in the presence of a solvent such as aromatic hydrocarbons, for example, toluene, xylene and ketones, such as, methyl ethyl ketone and methyl isobutyl ketone. The polyepoxide and the polyether polyol are heated together, for example at a temperature of at least 75° C. (167° F.), for example at least 90° C. (194° F.), such as 100 (212° F.) to 180° C. (356° F.), usually in the presence of a catalyst such as 0.05 to 2 percent by weight tertiary amines or quaternary ammonium bases. The time the polyepoxide and polyether polyol are heated together will vary depending on the amounts contacted, how they are contacted, the degree of agitation, temperature, and the presence of catalyst. The reaction is allowed to peak at the exothermic temperature. The oven is cooled to a range of about 149° C. (300° F.) to about 177° C. (350° F.), for example 160° C. (320° F.) where it remains for about an hour. The temperature of the oven is adjusted and when the batch cools to a temperature in the range of about 135° C. (275° F.) to about 163° C. (325° F.), for example 149° C. (300° F.), a crosslinking agent is blended into the batch for a time sufficient to obtain a homogeneous mixture. The batch is further cooled to a temperature in the range of about 93° C. (200° F.) to about 121° C. (250° F.), for example to 107° C. (225° F.), and a cationic group former, such as an amine, is added. The temperature of the batch is raised to a temperature in the range of about 50° C. (122° F.) to 150° C. (302° F.), for example 121° C. (250° F.).

A premix of a curing catalyst, water and an acid is mixed until a clear solution is achieved. The premix is combined with additional water and additional acid. The additional acid can be the same or a different acid than used to form the original premix. The final premix is added to the resinous batch and stirred until a homogeneous mixture is obtained, for example about 3 days. Any additives and coalescing solvents can be added at this time.

In an exemplary embodiment, a pigment paste next is formulated. A grind resin is combined with water and a nonsurfactant to achieve a homogeneous mixture. A pigment is added to the mixture and blending is continued. Additional water may be added. The mixture is ground at a temperature in the range of 27° C. (80° F.) to 38° C. (100° F.), for example 32° C. (90° F.) until a Hegman reading of greater than 7 is achieved. As noted above, the pigment paste and the film-forming binder are then combined in a pigment-to-film-forming binder weight ratio of, for example, less than about 0.5:1, for example less than about 0.4:1, such as about 0.2 to 0.4:1.

The following is an example of a method for fabricating coating compositions in accordance with an exemplary embodiment. The example is provided for illustration purposes only and is not meant to limit the various embodiments of the present invention in any way.

### Examples

### Film-Forming Binder

Approximately 159.6 grams (g) of EPON™ Resin 828, an undiluted clear difunctional bisphenol A/epichlorohydrin-derived liquid epoxy resin, available from Momentive Specialty Chemicals, Inc. of Columbus, Ohio, 79.7 g bisphenol A, 11.84 g xylene and 0.15 g hydrocarbon phosphonium halide as a catalyst were charged in a glass vessel with a flow of nitrogen gas therein. The vessel was heated to 143.3° C. (290° F.) and the batch was allowed to peak at an exothermic temperature of 226.7° C. (440° F.). The vessel temperature was held at 160° C. (320° F.) for 1 hour. The temperature of the vessel then was adjusted to 107° C. (225° F.).

When the batch had cooled to 149° C. (300° F.), 41.42 g polyoxyalkylated bisphenol A and an alcohol-blocked aromatic polyisocyanate crosslinking agent were added. The batch was mixed for twenty minutes.

Cooling of the batch continued until the batch temperature reached 107° C. (225° F.). 11.11 g of diketimine was added. After 5 minutes, 9.28 g 2-methylaminoethanol was blended to the batch. The temperature of the vessel was raised to 121° C. (250° F.) and held there for one hour.

5.66 g bismuth oxide, 13.64 g deionized water, and 9.26 g methane sulfonic acid were blended together in a beaker until a clear solution appeared. This solution then was added to 8.13 g lactic acid and 426.2 deionized water and the entire premix was added to the batch.

### Grinding Resin

An exemplary grinding vehicle was produced by combining 21.68 g epoxy resin, which was the diglycidyl ether of bisphenol A, 0.02 g catalyst of hydrocarbon phosphonium halide, and 8.98 g bisphenol A in a glass vessel and heating to about 143° C. (290° F.). The components were allowed to react exothermically. The mixture was cooled to 138° C. (280° F.) and a 12.77 g polyisocyanate resin was added. The mixture was held at 121° C. (250° F.) for 2 hours. After two hours, 34.31 g ethylene glycol monobutylether was added to the batch with mixing and the batch was cooled to 88° C. (190° F.). Subsequently, 17.41 g polyurethane was added to the batch and the temperature of the batch was held at 88° C. (190° F.) for six hours. Then 4.84 g 2,4,7,9-tetramethyl-5-decyn-4,7-diol was added to the batch and mixed for thirty minutes.

### Red Pigment Paste

Approximately 22.6 g of the grinding resin described above was combined with 33.1 g of deionized water and 1.1 g Syn Fac® 8334 from Milliken Chemical with the mixing speed on 250 revolutions per minute (RPM). The mixture was blended for fifteen minutes. The speed of the mixer was increased to 1000 RPM and 5.4 g of dibutyl tin oxide, 0.6 g carbon black, 10.1 g titanium dioxide, 1.2 g phthalocyanine blue and 18.4 g iron oxide was added to the mixture. The mixture was blended for thirty minutes. An additional 7.4 g water was added and mixing continued at 1000 RPM for thirty minutes. The paste then was ground at 32° C. (90° F.) until a Hegman reading of greater than 7 was achieved.

### Grey Pigment Paste

Approximately 18.6 g of the grinding resin described above was combined with 34.6 g of deionized water, 1.0 g Syn Fac® 8334, and 0.3 g lactic acid with the mixing speed on 200 RPM. The mixture was blended for fifteen minutes. The speed of the mixer was increased to 1500 RPM and 0.7 g bismuth oxide, 4.0 g dibutyl tin oxide, 12.0 g titanium dioxide, 16.3 g an extender pigment of barium sulfate, 0.4 g carbon black, and 4.9 g hydrated aluminum silicate was added to the mixture. The mixture was blended for thirty minutes. An additional 7.4 g water was added and mixing continued at 1500 RPM for thirty minutes. The paste then was ground at 32° C. (90° F.) until a Hegman reading of greater than 7 was achieved.

### Red Coating Composition 1

Approximately 548 g of film-forming binder and approximately 500 g of red pigment paste were combined to form a red coating composition.

### Red Coating Composition 2

Approximately 381.5 g of film-forming binder, 3 g of a 10/90 wt./% blend of dimethyl glutarate and dimethyl ester hexanedioic acid, respectively, 2 g of ethylene glycol monobutylether, and 109.3 g of red pigment paste were combined to form a red coating composition.

### Grey Coating Composition

Approximately 155 g of film-forming binder and approximately 112 g of grey pigment paste were combined to form a grey coating composition.

Accordingly, coil coating compositions are provided. The coil coating compositions comprise an aqueous carrier and a film-forming binder dispersed in an aqueous carrier. The film-forming binder comprise an epoxy-amine adduct and a blocked polyisocyanate crosslinking agent. The film-forming binder has associated amine/acid groups until subjected to heat of at least about 165.5° C. (330° F.). In addition, the coil coating composition comprises a pigment and a grinding resin. The coil coating composition has a solids content of at least about 40 weight percent based on a total weight of the coating composition. In this regard, the coil coating composition provides better corrosion resistance that conventional coil coating compositions and a lower VOC content.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A coated metal structure comprising:
a metal structure; and
a coating composition disposed on the metal structure, wherein the coating composition comprises:
an aqueous carrier;
a film-forming binder dispersed in the aqueous carrier, the film-forming binder comprising an epoxy-amine adduct and a blocked polyisocyanate crosslinking agent, wherein the film-forming binder has associated amine/acid groups until subjected to heat of at least about 165.5° C. (330° F.);
a pigment; and
a grinding resin,
wherein the coating composition as applied on the metal structure has a solids content of at least about 40 wt. % based on a total weight of the coating composition.

2. The coated metal structure of claim 1, wherein the metal structure is chosen from stamped metal parts, extruded metal parts, or molded metal parts.

3. The coated metal structure of claim 2, wherein the metal structure is a metal coil.

4. The coated metal structure of claim 1, wherein the coating composition as applied on the metal structure has a solids content in a range of about 40 wt. % to about 60 wt. % based on the total weight of the coating composition.

5. The coated metal structure of claim 1, wherein the coating composition as applied on the metal structure has a solids content in a range of about 50 wt. % based on the total weight of the coating composition.

6. The coated metal structure of claim 1, wherein the epoxy-amine adduct comprises a reaction product of a polyepoxide and a polyether polyol.

7. The coating composition of claim 6, wherein the polyepoxide is a polyglycidyl ether of a cyclic polyol.

8. The coating composition of claim 6, wherein the polyepoxide comprises a bisphenol A/epichlorohydrin-derived liquid epoxy resin.

9. The coating composition of claim 1, wherein the epoxy-amine adduct comprises a monoamine.

10. The coating composition of claim 9, wherein the monoamine is chosen from the group comprising diethyl amine, methyl ethyl amine, methyl ethanol amine, ethyl ethanol amine, mono ethanol amine, ethyl amine, dimethyl amine, diethyl amine, propyl amine, dipropyl amine, isopropyl amine, diisopropyl amine, butyl amine, and dibutyl amine.

11. The coating composition of claim 9, wherein the epoxy-amine adduct comprises a ketimine of a polyamine.

12. The coating composition of claim 1, wherein the blocked polyisocyanate crosslinking agent is chosen from the group comprising aliphatic, cycloaliphatic and aromatic isocyanates.

13. The coating composition of claim 1, wherein a pigment-to-film-forming binder weight ratio is less than about 0.5:1.

14. A method for coating a metal structure, wherein the method comprises the steps of:
providing the metal structure; and
coating the metal structure with a coating composition, wherein the coating composition comprises:
an aqueous carrier;
a film-forming binder dispersed in the aqueous carrier, the film-forming binder comprising an epoxy-amine adduct and a blocked polyisocyanate crosslinking agent, wherein the film-forming binder has associated amine/acid groups until subjected to heat of at least about 165.5° C. (330° F.);
a pigment; and
a grinding resin,
wherein the coating composition as applied on the metal structure has a solids content of at least about 40 wt. % based on a total weight of the coating composition.

15. The method of claim 14, wherein the coating composition as applied on the metal structure has a solids content in a range of about 40 wt. % to about 60 wt. % based on the total weight of the coating composition.

16. The method of claim 15, wherein the coating composition as applied on the metal structure has a solids content in the range of about 50 wt. % based on the total weight of the coating composition.

17. The method of claim 14, wherein the polyepoxide is produced by etherification of a polyhydric phenol with polyglycidyl ethers.

18. The method of claim 17, wherein the polyepoxide is produced by etherification of epichlorohydrin and bisphenol A.

19. The method of claim 14, wherein the film-forming binder and the pigment paste are present in the coating composition as applied on the metal structure at a pigment-to-film-forming binder weight ratio of less than about 0.5:1.

20. A method for coil coating a metal coil, the method comprising the steps of:
unwinding a metal strip from a coil thereof;
cleaning the metal strip;
coating at least one surface of the metal strip with a coating composition to form a coated metal strip, the coating composition comprising:
an aqueous carrier;
a film-forming binder dispersed in the aqueous carrier, the film-forming binder comprising an epoxy-amine adduct and a blocked polyisocyanate crosslinking agent, wherein the film-forming binder has associated amine/acid groups until subjected to heat of at least about 165.5° C. (330° F.);
a pigment; and
a grinding resin,
wherein the coating composition as applied on the metal strip has a solids content of at least about 40 weight percent based on a total weight of the coating composition; and
heating the coated metal strip.
